(19) United States
(12) Patent Application Publication
(10) Pub. No.: US 2026/0158581 A1
(43) Pub. Date: Jun. 11, 2026

(54) ENCAPSULATING APPARATUSES FOR USE WITH WELDING SYSTEMS AND PROCESSES

(71) Applicant: Edison Welding Institute, Inc., Columbus, OH (US)

(72) Inventors: Dennis Harwig, Columbus, OH (US); J. Logan McNeil, Columbus, OH (US); Michael Carney, Columbus, OH (US); Stacey Smith, Columbus, OH (US)

(21) Appl. No.: 18/975,264

(22) Filed: Dec. 10, 2024

(51) Int. Cl. B23K 9/32; B23K 9/16

(52) U.S. Cl. CPC B23K 9/32; B23K 9/164

(57) ABSTRACT

A device for use with welding systems and processes, comprising an encapsulating apparatus configured to encapsulate a welding torch nozzle at the tip thereof, wherein the apparatus includes an upper body portion which mounts on the nozzle; and a lower body portion which extends beyond the tip of the nozzle toward a work surface; and wherein during a welding process the apparatus encapsulates a welding electrode passing through the tip of the nozzle, an arc generated by the welding torch, and a weld pool surface directly above the work surface during deposition of the weld pool, and wherein the encapsulating apparatus prevents atmospheric gases from entering the weld pool during the welding process and reduces the shielding gas requirements compared to current gas shielded torch apparatuses, and wherein derivatives of the lower body portion are configured to accommodate unique welding grooves, joint designs, and DED additive manufacturing work piece geometries.

### STATEMENT REGARDING FEDERALLY FUNDED RESEARCH

The disclosed technology was made with government support under U.S. Government Contract No. N00014-21-C-1074 awarded by the United States Office of Naval Research (ONR). The government has certain rights in the disclosed technology.

### BACKGROUND

The disclosed technology relates in general to welding systems, apparatuses, and methods, and more specifically to a high-efficiency gas shielding “encapsulated arc apparatus” for use primarily in gas shielded consumable electrode arc welding processes such as gas shielded flux cored arc welding (GS-FCAW), gas metal arc welding (GMAW), which is also known as metal inert gas (MIG) and metal active gas (MAG), and directed energy deposition (DED) additive manufacturing.

Shielding gas used for DED and other arc welding applications is considered an essential component of the welding process as it provides protection from atmospheric gas contamination caused by excessive oxygen and nitrogen, for example, which may cause brittleness in metals and alloys. Shielding gas assists in achieving a defect-free deposit or weld and also influences material properties such as strength and impact toughness, and arc metal transfer mechanisms that are characterized as globular, drop, pulse drop, spray, and short-circuit. A metal transfer type is based on shielding gas, consumable electrode type, diameter, and electrical power characteristics.

Arc DED typically utilizes a welding apparatus that includes computer-aided manufacturing software for automating feature creation by making deposits (also known as beads) to create layers, and then utilizes a controlled path plan to build layer-by-layer. DED feature creation software can be used to automate building metal parts and components, adding features to parts or components, and repairing parts and components. Because DED additive manufacturing may create hundreds or thousands of deposits, shielding gas consumption is considerable when using flow rate requirements specified by conventional arc welding torches and processes.

The welding industry has attempted to reduce shielding gas consumption by developing self-shielded flux core wires that are used in applications wherein shielding gas cannot be delivered to a welding torch, or in certain point-of-need environments. Self-shielded flux cored arc welding (SS-FCAW) is commonly utilized, for example, in building and bridge fabrication and in construction for welding in outdoor and potential high-wind environments. To ensure weld soundness and quality, self-shielded consumable electrodes are designed with heavy slag that protects the molten weld pool from the atmosphere and improves out of position welding by using slagging minerals that melt and freeze at temperatures lower than that of the alloy being deposited. The heavy slag, however, must be removed after each deposit when overlapping weld deposits are needed to fill a welding groove and/or to make a joint fillet between adjacent surfaces. SS-FCAW electrodes also produce significant spatter. Heavy slags and spatter significantly increase time and costs in automated welding and DED process applications because the processes must be stopped to remove the slag and heavy spatter from each deposit before an overlapping deposit can be made. As such, SS-FCAW is not an economical process for reducing shielding gas consumption for high duty arc welding and DED applications.

High quality gas metal arc (GMA) and flux cored arc (FCA) welding and/or DED typically utilize argon-based shielding gases for providing superior shielding properties compared to 100% carbon dioxide (CO₂) shielding gas. CO₂ is typically preferred over argon based shielding gas since it is lower in cost, more widely available, and can be made at the point of need. However, 100% CO₂ promotes large globular droplets (the molten drop forming on the electrode tip) that are prone to spatter due to droplet short circuiting with the weld pool. Another commonly used shielding gas is Argon (Ar)-25% CO₂. Ar-25% CO₂, which can be used with both GMA and FCA electrodes. Ar-25% CO₂ shielding gas also promotes globular transfer, although spatter is less than 100% CO₂ because the droplets are typically smaller.

In GMA, spatter-free or low-spatter metal transfer may be possible with argon rich shielding gases that have controlled additions of oxygen (typically 2-5%) or CO₂ (typically 2-20%). The oxygen and/or CO₂ dissociates in the arc to produce gas ions, and free oxygen ions are absorbed by the electrode droplet and weld pool and act to reduce the molten metal surface tension. Lower surface tension makes detaching smaller drops easier based on gravity and electromagnetic pinch forces that compete with surface tension that resists drop detachment from the electrode tip droplet. Smaller drops are less likely to touch the weld pool and short and, therefore, can provide spatter-free metal transfer. Depending on the electrical current, drop and spray transfer can be spatter-free with sufficient arc length between the electrode tip and the weld pool.

With regard to the methods and techniques described herein, shielding gas flow rate is an important factor. If flow rate is too low, atmospheric contamination will occur if atmospheric gases are not sufficiently displaced over the weld pool area and the cooling deposited metal. If the flow rate is too high, turbulence will occur over the weld pool and aspirate air into the shielding gas thereby causing contamination. Ideally, the shielding gas flow displaces atmosphere around the arc and over the weld pool with a lamellar flow of gas that mitigates mixing with the surrounding atmospheric gases.

Shielding gas flow rate generally depends on nozzle size and current, to some extent. Welding torch (or gun) terminal apparatuses typically include a shielding diffuser and a contact tip that transfers electrical power to a consumable electrode. The shielding diffuser and contact tip are shrouded by a shielding nozzle. Shielding nozzle diameter is typically related to the current capacity of the welding gun as well as the intended welding electrical current and voltage duty. Larger nozzles (e.g., ˜25-mm (1-inch) diameter) are used with higher current duty torches compared to lower current torches that may have nozzles of only about 12.5-mm (½-inch) in diameter. Recommended flow rate is typically specified in cubic feet per hour (CFH) or liters per hour (LPH), and typical example shielding gas flow rates are about 22-27 CFH for ½-inch nozzles, about 30-35 CFH for ⅝-inch nozzles, about 30-40 CFH for ¾-inch nozzles, and about 40-50 CFH for 1-inch nozzles.

Most commercial welding torches are designed to set the contact tip flush, proud (typically about 3-mm or ⅛-inch), or recessed (typically about 3-mm or ⅛-inch) relative to the shielding nozzle. The terminal apparatus is typically made from copper alloys or other electrically conductive metals/alloys for delivering current from the welding cables to the contact tip and removing absorbed arc heat (that is usually about 10,000° F.) from the contact tip and the shielding nozzle. Torches are typically specified as gas or water cooled, wherein the shielding gas removes heat as it passes through the torch for the former, and water-cooling circuits are embedded in the torch for additional cooling for the latter.

Welding procedures commonly specify a contact tip-to-work distance during welding that determines nozzle-to-work distance. The contact tip-to-work distance generally increases from about 12-mm (½-inch) for small electrodes and deposit sizes, to over about 25-mm (1-inch) for larger electrodes and deposits. The contact tip-to-work distance is generally set to accommodate sufficient electrical electrode extension (so the arc does not melt the contact tip), sufficient arc length (to control metal transfer and short circuit induced spatter), and the pool thickness. For most DED and arc welding applications, a typical contact tip-to-work distance is about 16-mm (⅝-inch) for smaller deposits and about 19-mm (¾-inch) for larger deposits, with a 1.2-mm electrode using about 2- to 3-mm arc length and about 19-mm (¾-inch) to about 25-mm (1-inch) for 1.6-mm (0.062-inch) electrodes using about 3- to 4-mm arc length, respectively, as a typical range in welding procedures. Therefore, the nozzle-to-work distance is typically equivalent to the contact tip-to-work distance +/−about 3-mm (⅛-inch), depending on the contact tip setup.

With regard to the described techniques and methods, there is an ongoing need for modified welding apparatuses and improved shielding technology that reduces gas consumption in gas shielded arc welding processes and DED welding applications.

### SUMMARY

The following provides a summary of certain example implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more”.

One implementation of the disclosed technology provides a first device for use with welding systems and processes. This device comprises an encapsulating apparatus configured to encapsulate a welding torch nozzle at the tip thereof, wherein the encapsulating apparatus includes an upper body portion which mounts on the welding torch nozzle; and a lower body portion which extends beyond the tip of the welding torch nozzle toward a work surface; and wherein during a welding process, the encapsulating apparatus encapsulates a welding electrode passing through the tip of the welding torch nozzle, an arc generated by the welding torch, and a weld pool surface directly above the work surface during deposition of the weld pool, and wherein the encapsulating apparatus prevents atmospheric gases from entering the weld pool during the welding process with lower shielding gas flow rates as compared to standard typical nozzle to work distances.

The welding process may be a high efficiency, gas shielded, gas metal, or flux cored arc welding-based process. The welding process may be used for directed energy deposition additive manufacturing. The encapsulating apparatus may be made from a high-conductivity material that prevents radiant heat from the welding process from causing changes in the geometry of the encapsulating apparatus. The high-conductivity material may be copper, one or more copper alloys, or other alloy materials with internal cooling channels to improve the duty cycle and heat removal. In some implementations, the upper body portion is cylindrical and includes an internal channel having a diameter slightly greater than an outer diameter of the welding torch. In some implementations, the lower body portion includes an outer diameter that is the same as the outer diameter of the upper body portion, and wherein the lower body portion includes an inner diameter that is the same as the inner diameter of the upper body portion. In some implementations, the lower body portion includes a single bead wall design having a tunnel feature that improves encapsulation for thin weld features. In some implementations, the lower body portion is machined to match a welding groove profile on the work surface while providing clearance for the weld pool and a minimal gap to travel over the work surface without contact. In some implementations, the lower body portion includes a cutout region that improves encapsulation for bulk weld features. In some implementations, the lower body portion includes an omni-directional skirt feature that is configured to minimize gap or allow sliding contact over the work surface. In some implementations, the lower body portion includes a frame having a predetermined geometry that corresponds to the geometry of a particular type of groove, wherein the frame serves as a substrate to which front, rear, and side shields are attached for enclosing a welding torch within the device, or to which first and second pivoting side shields are attached for enclosing a welding torch within the device. The encapsulating apparatus may include a mechanism for adjusting the position of the encapsulating apparatus on the welding torch nozzle in an upward or downward manner.

Another implementation of the disclosed technology provides a second device for use with welding systems and processes. This device comprises an encapsulating apparatus configured to encapsulate a welding torch nozzle at the tip thereof, wherein the encapsulating apparatus includes an upper body portion which mounts on the welding torch nozzle; and a lower body portion which extends beyond the tip of the welding torch nozzle toward a work surface; and wherein during a welding process, the encapsulating apparatus encapsulates a welding electrode passing through the tip of the welding torch nozzle, an arc generated by the welding torch, and a weld pool surface directly above the work surface during deposition of the weld pool, wherein the encapsulating apparatus prevents atmospheric gases from entering the weld pool during the welding process, and wherein the welding process is a high efficiency, gas shielded, gas metal, or flux cored arc welding-based process used for directed energy deposition additive manufacturing.

The encapsulating apparatus may be made from a high-conductivity material that prevents radiant heat from the welding process from causing changes in the geometry of the encapsulating apparatus. The high-conductivity material may be copper. In some implementations, the upper body portion is cylindrical and includes an internal channel having a diameter slightly greater than an outer diameter of the welding torch. In some implementations, the lower body portion includes an outer diameter that is the same as the outer diameter of the upper body portion, and wherein the lower body portion includes an inner diameter that is the same as the inner diameter of the upper body portion. In some implementations, the lower body portion includes a single bead wall design having a tunnel feature that improves encapsulation for thin weld features. In some implementations, the lower body portion includes a cutout region that improves encapsulation for bulk weld or additive manufactured features. In some implementations, the lower body portion includes an omni-directional skirt feature. In some implementations, the lower body portion includes a frame having a predetermined geometry that corresponds to the geometry of a particular type of groove, wherein the frame serves as a substrate to which front, rear, and side shields are attached for enclosing a welding torch within the device, or to which first and second pivoting side shields are attached for enclosing a welding torch within the device. The encapsulating apparatus may include a mechanism for adjusting the position of the encapsulating apparatus on the welding torch nozzle in an upward or downward manner.

Still another implementation of the disclosed technology provides a third device for use with welding systems and processes. This device comprises an encapsulating apparatus configured to encapsulate a welding torch nozzle at the tip thereof, wherein the encapsulating apparatus includes an upper body portion which mounts on the welding torch nozzle; and a lower body portion which extends beyond the tip of the welding torch nozzle toward a work surface; and wherein during a welding process, the encapsulating apparatus encapsulates a welding electrode passing through the tip of the welding torch nozzle, an arc generated by the welding torch, and a weld pool surface directly above the work surface during deposition of the weld pool, wherein the encapsulating apparatus prevents atmospheric gases from entering the weld pool during the welding process, wherein the welding process is a high efficiency, gas shielded, gas metal, or flux cored arc welding-based process used for directed energy deposition additive manufacturing, and wherein the encapsulating apparatus is made from a high-conductivity material that prevents radiant heat from the welding process from causing changes in the geometry of the encapsulating apparatus.

In some implementations, the lower body portion includes an outer diameter that is the same as the outer diameter of the upper body portion, and wherein the lower body portion includes an inner diameter that is the same as the inner diameter of the upper body portion. In some implementations, the lower body portion includes a single bead wall design having a tunnel feature that improves encapsulation for thin weld features. In some implementations, the lower body portion includes a cutout region that improves encapsulation for bulk weld features. In some implementations, the lower body portion includes an omni-directional skirt feature. In some implementations, the lower body portion includes a frame having a predetermined geometry that corresponds to the geometry of a particular type of groove, wherein the frame serves as a substrate to which front, rear, and side shields are attached for enclosing a welding torch within the device, or to which first and second pivoting side shields are attached for enclosing a welding torch within the device.

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the descriptions provided herein are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed technology and together with the general description given above and detailed description given below, serve to explain the principles of the disclosed subject matter, and wherein:

FIG. 1 is a front view of a first example implementation of the disclosed encapsulating apparatus, wherein the encapsulating apparatus is shown mounted on the tip of a welding torch nozzle;

FIG. 2 is a cross-sectional view of the encapsulating apparatus of FIG. 1 mounted on the tip of a welding torch nozzle;

FIG. 3 is a cross-sectional view of the encapsulating apparatus of FIG. 1 mounted on the tip of a welding torch nozzle, wherein a set screw has been included to allow for positional adjustment of the encapsulating apparatus on the welding torch nozzle;

FIG. 4 is a front view of a second example implementation of the disclosed encapsulating apparatus, wherein the encapsulating apparatus is shown mounted on the tip of a welding torch nozzle, and wherein the encapsulating apparatus includes a single bead wall design having a tunnel feature for improving encapsulation for thin features (welds);

FIG. 5 is a cross-sectional view of the encapsulating apparatus of FIG. 4 mounted on the tip of a welding torch nozzle;

FIG. 6 is a cross-sectional view of the encapsulating apparatus of FIG. 4 mounted on the tip of a welding torch nozzle, wherein a set screw has been included to allow for positional adjustment of the encapsulating apparatus on the welding torch nozzle;

FIG. 7 is a front view of a third example implementation of the disclosed encapsulating apparatus, wherein the encapsulating apparatus is shown mounted on the tip of a welding torch nozzle, and wherein the design of the encapsulating apparatus improves encapsulation for bulk features (welds);

FIG. 8 is a cross-sectional view of the encapsulating apparatus of FIG. 7 mounted on the tip of a welding torch nozzle;

FIGS. 9A-9C depict the encapsulating apparatuses of FIGS. 1, 4, and 7 having a lower body portion that is machined to match an additive manufacturing profile on a work surface while providing clearance for a weld pool and a minimal gap to travel over the work surface without contact, wherein FIG. 9A is a front view of the encapsulating apparatus of FIG. 1, wherein FIG. 9B is a front view of the encapsulating apparatus of FIG. 4, and wherein FIG. 9C is a front view of the encapsulating apparatus of FIG. 7;

FIG. 10 is a front, perspective view of a fourth example implementation of the disclosed encapsulating apparatus, wherein the encapsulating apparatus is shown mounted on the tip of a welding torch nozzle, and wherein the encapsulating apparatus includes an omni-directional skirt feature;

FIG. 11 is a cross-sectional view of the encapsulating apparatus of FIG. 10 mounted on the tip of a welding torch nozzle;

FIG. 12 depicts the encapsulating apparatus of FIG. 10 in use on a robotic welding system;

FIG. 13 depcits oxygen and nitrogen testing data generated in welding processes using the disclosed encapsulating apparatus compared to welding processes wherein the disclosed encapsulating apparatus is absent;

FIG. 14 provides two photographs depicting surface breaking porosity and instability in an experimental wall directed energy deposition (DED) process utilizing conventional shielded gas metal arc (GMA) welding methods and without the disclosed High-Efficiency Shielded (HES) apparatus;

FIG. 15 depicts an example experimental set-up of an HES-GMA wall DED process that utilizes the encapsulating apparatus of FIG. 10;

FIGS. 16A-16B are photographs depicting an experimental wall having no defects and no internal porosity that was formed utilizing the set-up depicted in FIG. 15, wherein FIG. 16A is a top-down view of the wall, and wherein FIG. 16B is a perspective side view of the wall;

FIG. 17 provides two photographs showing surface breaking porosity of an experimental V-groove DED process that utilizes conventional GMA welding methods without the disclosed HES encapsulating apparatus;

FIG. 18 depicts an example experimental set-up of an HES-GMA V-groove DED process that utilizes the encapsulating apparatus of FIG. 10;

FIG. 19 is a photograph depicting a top-down view of an experimental V-groove having no defects and no internal porosity that was formed utilizing the experimental set-up of FIG. 18;

FIG. 20 is a front, perspective view of a fifth example implementation of the disclosed encapsulating apparatus, wherein the encapsulating apparatus includes a frame having a predetermined geometry that corresponds to the geometry of a particular type of groove, and wherein the frame serves as a substrate to which front, rear, and side shields are attached for enclosing a welding torch within the apparatus;

FIG. 21 depicts the encapsulating apparatus of FIG. 20 being used within an example groove geometry, wherein the groove includes a backing bar and is beveled at a 45° angle;

FIG. 22 depicts the encapsulating apparatus of FIG. 20 attached to a welding torch and with the side shielding removed to illustrate the placement of the welding torch within the encapsulating apparatus and V-shaped groove;

FIG. 23 is a front, perspective view of a sixth example implementation of the disclosed encapsulating apparatus, wherein the encapsulating apparatus includes a frame having a predetermined geometry that corresponds to the geometry of a particular type of groove, and wherein the frame serves as a substrate to which first and second pivoting side shields are attached for enclosing a welding torch within the apparatus; and

FIG. 24 is an alternate front, perspective view of the encapsulating apparatus of FIG. 23.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed technology. Accordingly, the following implementations are set forth without any loss of generality to, and without imposing limitations upon, the claimed subject matter.

The examples discussed herein are examples only and are provided to assist in the explanation of the apparatuses, devices, systems, and methods described herein. None of the features or components shown in the drawings or discussed below should be taken as required for any specific implementation of any of these the apparatuses, devices, systems or methods unless specifically designated as such. For ease of reading and clarity, certain components, modules, or methods may be described solely in connection with a specific Figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Implementations of the disclosed technology provide an encapsulated arc and deposit pool high-efficiency gas shielding and torch apparatus. This technology has been validated for welding and DED applications where shielding gas flow rate requirements for sound deposits were significantly reduced compared to those used in conventional arc welding torch apparatuses. An encapsulating apparatus encapsulates the electrode, arc, and deposit pool surface directly above work surface while deposition is occurring and prevent atmospheric gases from entering the weld pool. The encapsulating apparatus prevents atmospheric gases from interacting with the deposition pool, and contains shielding gas formed from electrode flux and arc metal vapor that displace atmospheric gas contamination. By reducing pool absorption of oxygen, nitrogen and hydrogen, the deposit exhibits more desirable material properties (see FIG. 13). In an example application involving stainless steel, the encapsulating apparatus prevented atmospheric gases such as oxygen from forming oxides in the deposit and excessive scale on the deposit, and prevented nitrogen absorption into solution that would have caused a shift in weld metal ferrite thereby increasing cracking resistance and service performance. Some implementations include encapsulating devices that utilize a hard copper cup. These implementations are directed toward feature specific geometries for thin wall, thick sections, and work surface geometry. Other implementations include encapsulating devices that utilize a thin metal sheet and brass brushes that form a “flexible metal skirt” around a torch nozzle to create a labyrinth condition which blocks the flow of gases into and out of the encapsulated arc process area and can flex and form over surface geometries. These implementations are omnidirectional because the thin metal sheet and brush, flexible metal skirt can form and slide over work piece (prior deposit/substrate) geometry without interfering with the arc or weld pool.

The disclosed technology provides a high efficiency gas shielded, gas metal and/or flux cored arc welding-based system and process that enables expeditionary and/or high efficiency additive manufacturing (AM) of high integrity components with little shielding gas (e.g., approximately 1/10th of legacy processes) and that provides spatter free high duty metal transfer. This process, which is referred to herein as high efficiency shielded arc (HES-A) directed energy deposition (DED) AM, utilizes the following: (i) an advanced high duty gas shielding encapsulation torch apparatus for improving shielding over a weld pool with less gas; and (ii) gas shielded (e.g. flux-cored, metal-cored, and solid) electrodes at a fraction of recommended flow rates. The disclosed HES-A process enables welding and DED AM builds which require little to no shielding gas while still meeting property requirements of legacy GMA and FCA processes that use significantly greater volumes of shielding gas (e.g., 10X that of the disclosed process).

The disclosed technology improves pool protection and ensures high-quality deposits by: (i) encapsulating the shielding gas and metal vapor around the weld pool for shielding; and (ii) using an advanced encapsulating apparatus that withstands arc heat for long periods of time, thereby enabling high-duty DED. The disclosed technology may be used for defense, navy, and aerospace applications, in heavy industry, and in other industries involving manufacturing processes wherein carrying or sourcing shielding gas would be difficult or impossible. Further, the disclosed technology has been validated on welding and DED applications where the shielding gas flow rate requirements for sound deposits were significantly reduced as compared to those used in conventional arc welding torch apparatuses.

### I. High-Efficiency Shielded Systems

### A. Encapsulating Apparatus

Example implementations of the disclosed technology include an encapsulating “cup” that: (a) captures shielding gases created by a consumable electrode and arc that primarily includes CO₂ and metal vapors; (b) inhibits the mixing and absorption of atmospheric gases (O, N, and H) that negatively impact deposit properties; and (c) accommodates surface geometry of building parts by using geometrically customized “cup” features. In some implementations, the encapsulating cup provides a labyrinth-like environment by creating a physical barrier between edges of the cup and the work surface (substrate geometry) that makes atmospheric contamination more difficult and confines the shielding produced by the consumable electrode and arc.

Typically, gas metal arc welding (GMAW) relies on shielding gas such as argon, carbon dioxide or mixes thereof to provide a medium for the arc plasma and displaces atmospheric gas directly above the molten deposition (weld) pool. The pool must be shielded during metal transfer and through pool solidification as it travels to make “bead” deposits and build parts bead by bead, layer by layer for DED AM. Interactions with ambient air can have negative effects for certain types of material where monatomic oxygen and nitrogen are absorbed. This can lead to oxides and nitrides in the deposit which reduce strength, change phase balances that may impair properties, and form tenacious oxide scale that interferes with subsequent deposit fusion. In other words, oxygen and nitrogen found in ambient atmosphere can be absorbed by the molten pool and cause embrittlement, oxidation scale, and/or forms of gas-related property impairment.

Encapsulating the weld pool and creating a physical barrier from air means that the shielding gases typically present with traditional welding can be reduced and/or eliminated with a combination of encapsulation and custom encapsulated cup cooling to remove high rates of arc heating for high duty DED applications. The encapsulated cup design can take many forms incorporating flexible materials specifically designed for omni-directional capability or designs directed to certain deposition feature and/or weld joint geometry.

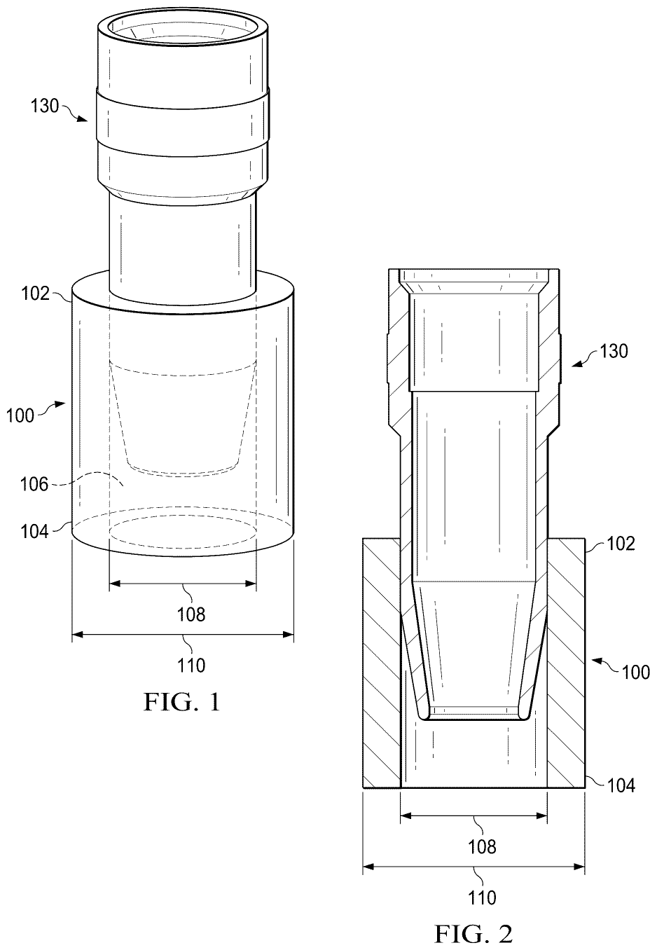

With reference to the Figures, FIGS. 1-3 depict an example implementation of the encapsulating cup component of the disclosed technology. In this implementation, encapsulating “cup” or apparatus 100, which includes upper portion 100 and lower portion 104, is a copper tube machined to increase the length of welding torch nozzle 130 to protect the weld pool from air contamination. Internal channel 106 extends though the length of encapsulating apparatus 100 and includes an internal diameter 108. Encapsulating apparatus 100 includes an outer diameter 110. Encapsulating apparatus 100 can be machined and attached to any suitable welding nozzle based on the size and design of the welding nozzle. In one implementation, inner diameter 108 of encapsulating apparatus 100 is designed to slide over the outside of an existing welding torch nozzle and is held in place using an adjustable set screw (120) that provides raising and lowering functionality for adjusting the encapsulated nozzle-to-workpiece distance. In various implementations, the shielding apparatus (i.e., encapsulating apparatus 100) and the encapsulated welding nozzle component (i.e., the encapsulated cup) may be separated or combined to improve functionality, performance and affordability. Encapsulating apparatus 100 may be customized for evaluating different encapsulated nozzle to workpiece distances and/or weld bead sizes.

To ensure high duty performance, some implementations of encapsulating apparatus 100 include integrated water-cooling channels that improve robustness and throughput by ensuring that encapsulating apparatus 100 does not melt or overheat under high-productivity applications such as, for example, DED builds. Some implementations of encapsulating apparatus 100 include straight walls of equal size around the weld pool, thereby providing omni-directional shielding and torch travel capabilities if the straight edges do not interfere with the depositing weld pool and/or existing baseplate or deposited geometry. Implementations of encapsulating apparatus 100 are made from a high-conductivity material (such as copper and/or one or more copper alloys) to ensure that radiant heat from the welding process will not cause geometrical changes to encapsulating apparatus 100 as a result of heat warping or high throughput processes that may affect geometry.

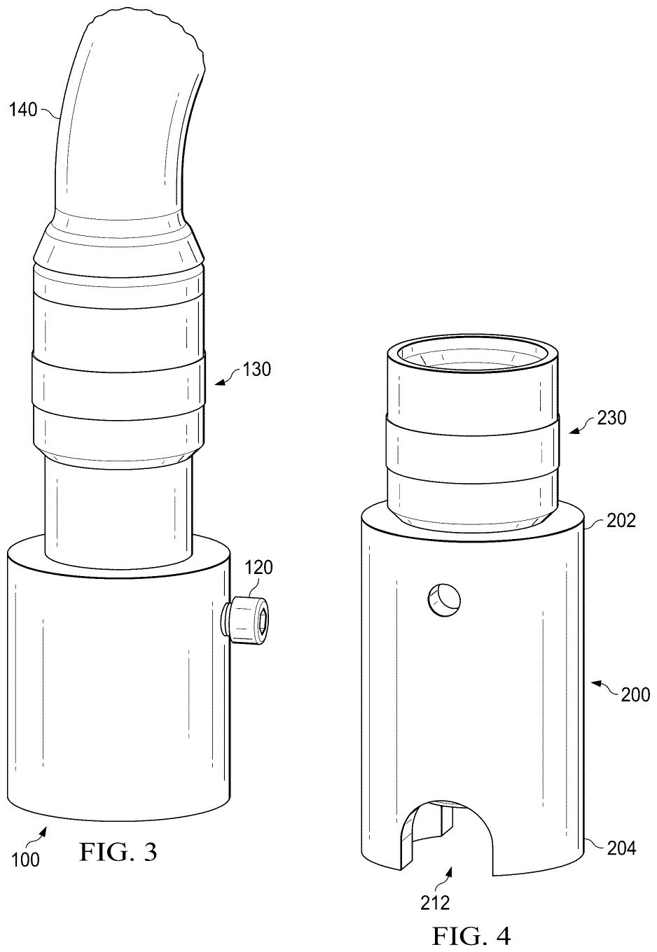

FIG. 1 depicts an example implementation of encapsulating apparatus 100 mounted on a commercially available Abicor Binzel commercially available welding torch nozzle (encapsulated cup). FIG. 2 provides a cross-sectional view of the configuration of FIG. 1. Encapsulating apparatus 100 may be adjusted in size and position to ensure maximum coverage of the weld pool deposit. FIG. 3 depicts a welding device that includes both encapsulated apparatus 130 (welding nozzle) and encapsulating apparatus 100 mounted robotic arm system 140, which is used to create weld deposits. Set screw 120 is included to ensure that encapsulating apparatus 100 can be adjusted and properly positioned.

### B. Single Bead Wall Encapsulating Apparatus

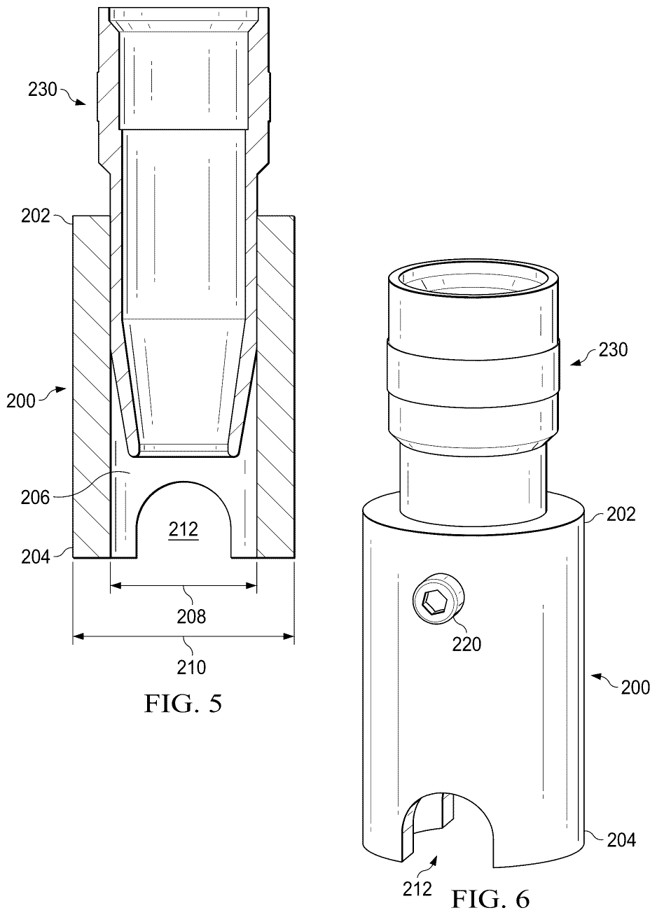

With reference to FIGS. 4-6, certain implementations of the disclosed encapsulating apparatus are adapted for use with certain predetermined weld geometries and deposition features. For many DED applications that involve 3D printing using metal, thin wall/single bead structures must be deposited where single welding passes are stacked on top of each other. Encapsulating apparatus 100, shown in FIG. 1, does not extend over the edges of single pass builds, meaning that ambient air has access to the sides of the melt pool as it is being deposited. The “tunnel” design of encapsulating apparatus 200 permits encapsulation to extend around the edges of a single wall build as it is being deposited for reducing the amount of distance across which ambient air has access to the melt pool as it is being deposited. This tunnel design is intended for use with a predetermined deposit size and includes high conductivity material (copper and/or one or more copper alloys) to ensure radiant heat from the welding process will not adversely affect the geometry of encapsulating apparatus 200. Overall size and tunnel width and height changes may be made based on deposit and encapsulation requirements. Encapsulating apparatus 200, which includes upper portion 202, lower portion 204, internal channel 206, inner diameter 208, outer diameter 210, and tunnel 212, may be used for single wall builds, which present a worst-case shielding condition compared to commercially available apparatus designs and shielding conditions. Encapsulating apparatus 200 is compatible with welding systems wherein torch necks can be changed or substituted, and wherein the welding system can switch to a single bead wall encapsulated cup design for achieving certain types of geometrical features. Some implementations include the addition of external or internal cooling channels for providing heat mitigation in high throughput applications.

FIG. 4 depicts an example implementation of encapsulating apparatus 200 showing a portion of the apparatus extending past the tip of welding torch 230, as well as a tunnel feature (212), formed in lower portion 204. Set screw 220 is included for adjusting encapsulated torch nozzle 230 to work piece distance. The disclosed tunnel configuration makes welding torch 230 bi-directional but improves the shielding capabilities for worst-case shielding conditions. FIG. 5 provides a cross-sectional view of encapsulating apparatus 200 and the interaction between encapsulating apparatus 200 and a commercially available Abicor Binzel torch nozzle. FIG. 6 depicts encapsulating apparatus 200 mounted on the Abicor Binzel torch nozzle. As previously indicated, the diameter of tunnel 212 in this implementation is widened compared to encapsulating apparatus 100 due to single bead feature size changes, and the position of encapsulating apparatus 200 may be adjusted on welding torch 230 as necessary to improve encapsulation of the weld pool for single bead feature DED builds.

### C. Bulk Feature Encapsulated Apparatus

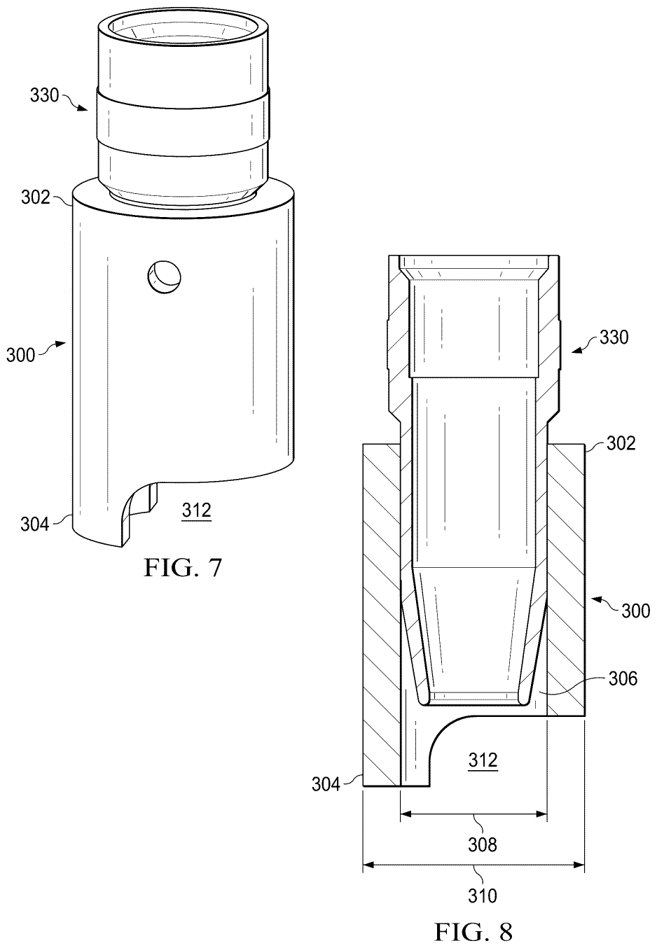

With reference to FIGS. 7-8, another example implementation of the disclosed technology provides a deposition apparatus that improves encapsulation as bulk features are deposited to help reduce the interaction of ambient air with the melt pool. In this implementation, encapsulating apparatus 300 includes upper portion 302, lower portion 304, internal channel 306, inner diameter 308, outer diameter 310, and cutout 312. The design of this implementation is predicated on the fact that existing beads are already deposited, and this particular apparatus can then be selected for bulk features involving deposition of a bead directly next to other beads on the same deposition layer. In use, the encapsulation provided by this implementation covers half of the bead while also travelling over top of a previously deposited bead into which a bead currently being deposited is tied. This implementation includes a high-conductivity material (copper and/or one or more copper alloys) to ensure that radiant heat of the welding torch nozzle does not adversely affect the geometry of the encapsulating apparatus. The encapsulating apparatus in this implementation is bi-directional rather than omni-directional, but the apparatus does provide significantly more encapsulation coverage than an omni-directional apparatus design. The contact to workpiece distance is adjustable using a set screw. A welding/DED system having torch neck changing capabilities and a welding torch that is compatible with this implementation of the encapsulating apparatus for bulk features is suitable for both single bead and bulk geometry encapsulating apparatuses, thereby permitting full flexibility between deposition strategies and feature types. Other implementations include external and internal cooling channels for mitigating heat buildup from the welding process in high productivity applications.

FIG. 7 depicts bulk feature encapsulating apparatus 300. Encapsulating apparatus 300 is adjustable using set screw 320, which engages the nozzle of welding torch 330. FIG. 8 is a cross-sectional view of bulk feature encapsulating apparatus 300 mounted on the nozzle of an Abicor Binzel welding torch. Inner diameter 308 of bulk feature encapsulating apparatus 300 may be adjusted to accommodate various torch nozzles and encapsulated apparatuses.

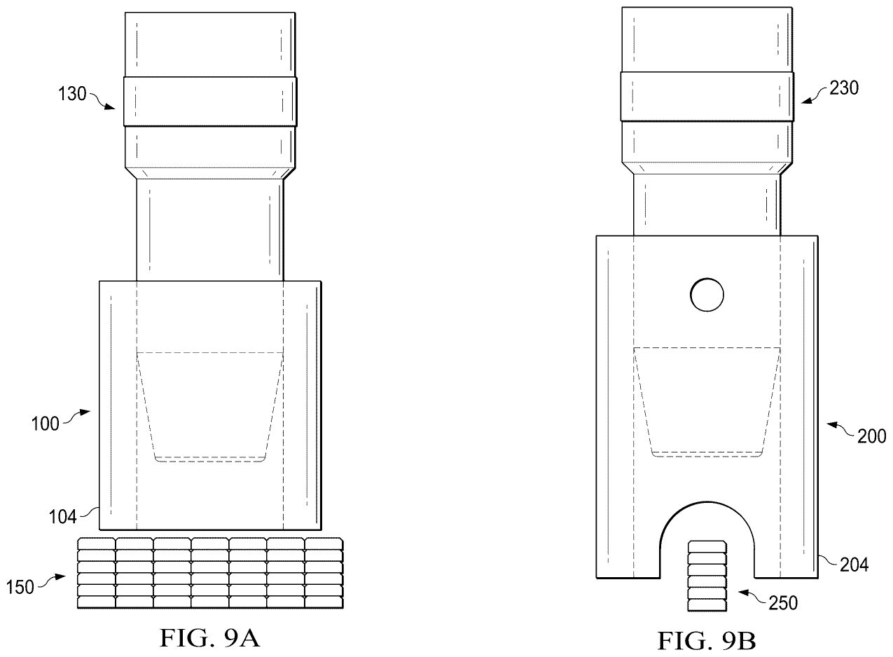

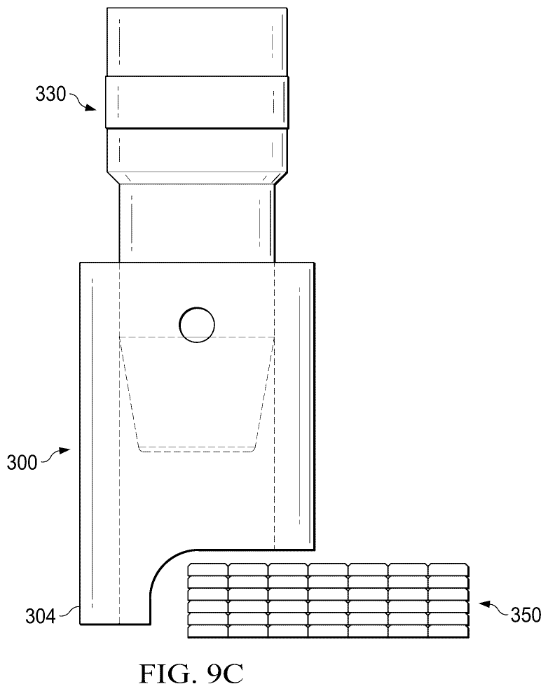

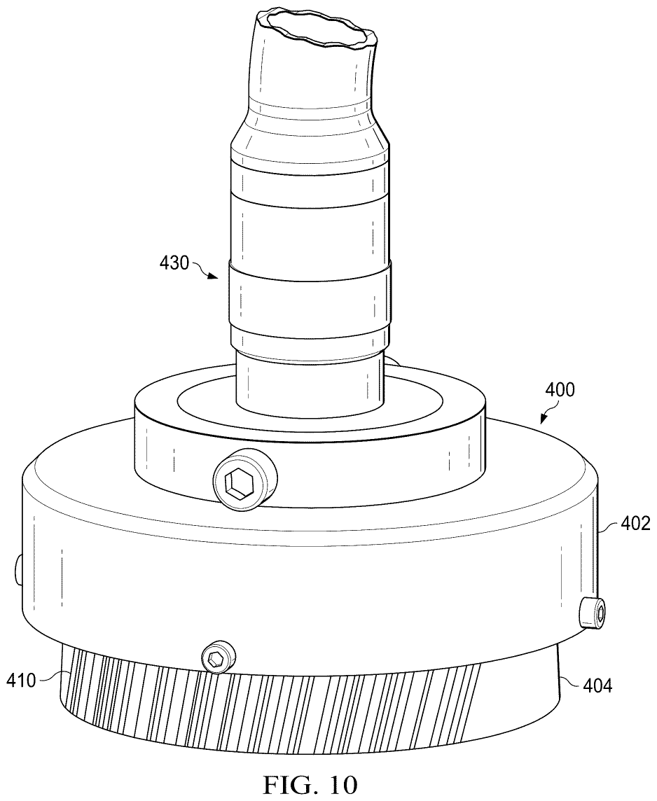

The implementations shown in FIGS. 9A-9C are intended for use with arc-DED (additively manufactured) type builds. As shown in FIG. 9A, lower portion 104 of encapsulating apparatus 100 is machined to match a flat multi-pass additive manufacturing and/or multi-pass welding profile 150 on a work surface while providing clearance for a weld pool and a minimal gap to travel over the work surface without contact. As shown in FIG. 9B, lower portion 204 of encapsulating apparatus 200 is machined to match a single bead additive manufacturing profile 250 on a work surface while providing clearance for a weld pool and a minimal gap to travel over the work surface without contact. As shown in FIG. 9C, lower portion 304 of encapsulating apparatus 300 can be machined to match an edge multi-pass additive manufacturing profile 350 on a work surface while providing clearance for a weld pool and a minimal gap to travel over the work surface without contact.

### D. Omni-Directional Encapsulating Skirt Apparatus

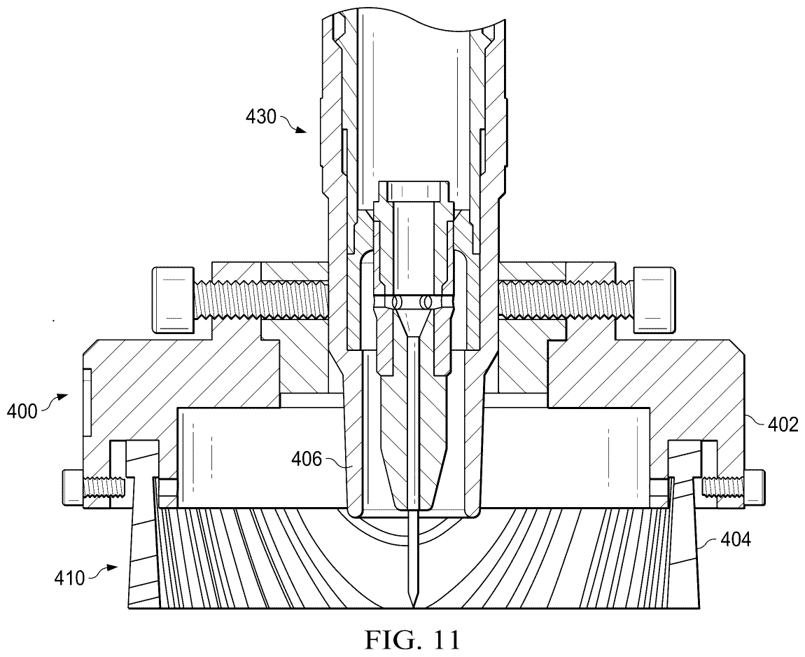

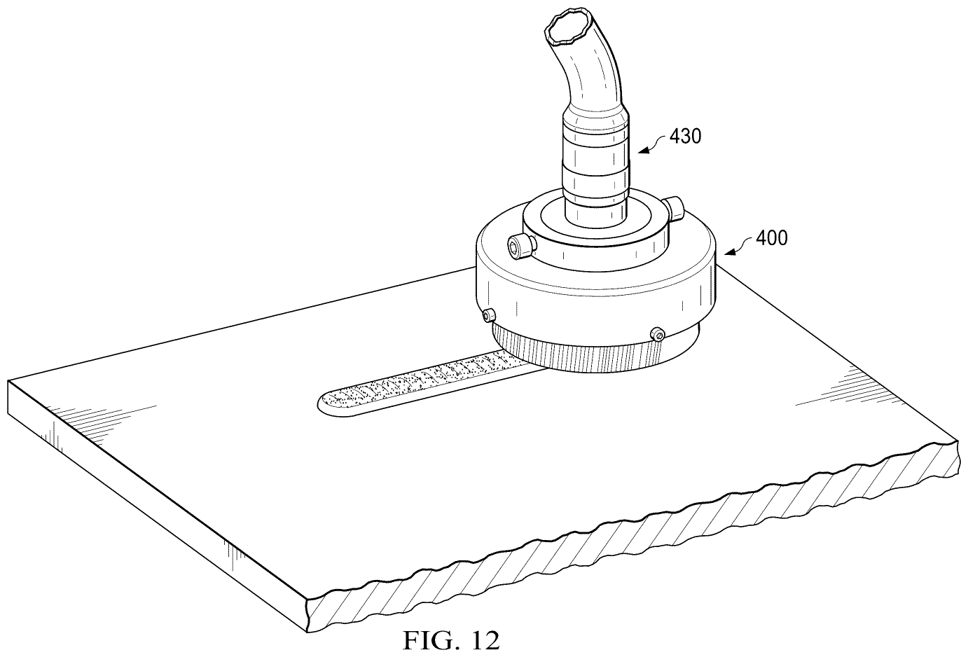

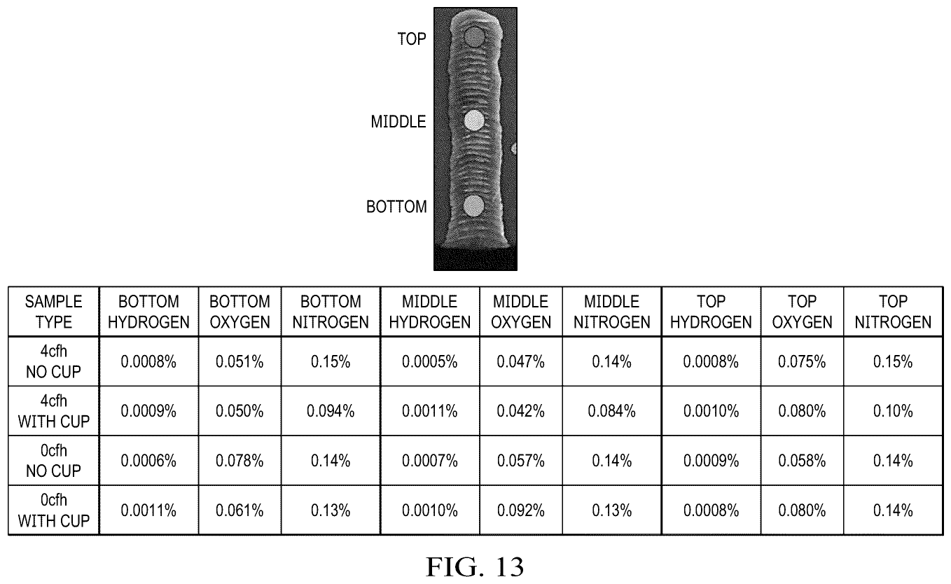

With reference to FIGS. 10-12, feature-specific encapsulation is useful for simplified geometries where single pass and bulk features interact in a simplistic way to produce weld geometries. However, for more complex DED builds and welding applications, omni-directional encapsulation is preferred as it provides flexibility for path planning and access. Accordingly, the implementation shown in FIGS. 10-12 depicts an omni-directional encapsulating apparatus having a skirt. In these Figures, encapsulating apparatus 400, which mounts on welding torch 430, includes upper portion 402, lower portion 404, internal channel 406, and skirt 410. This implementation increases the area covered by the encapsulating apparatus from the top down view, while adding a flexible skirt to ensure that the sides of the build, regardless of feature, remain encapsulated within a labyrinth condition to ensure that ambient air is not contaminating the weld pool as it is deposited. This implementation includes a custom bushing that permits easy switching between different welding apparatuses. Set screws are included for adjusting the height of the skirt relative to the work piece, depending on skirt stiffness and geometrical features the skirt must pass over. Brass brushes, stainless steel brushes, thin metal shimming cut with slits, and other types of skirts may be used to create a labyrinth condition which limits the access of ambient air to the melt pool. FIG. 10 provides a perspective view of an example omni-directional encapsulating skirt apparatus 400 and FIG. 11 provides a cross-sectional view of this implementation.

### II. Experimental Data

### Experiment 1

This experiment evaluated the effects of the disclosed high-efficiency shielded systems in a first electrode application involving a High Efficiency Shielded Flux Cored Arc (HES-FCA) directed energy deposition (DED) process with 316L stainless steel consumables. The results of this experiment, shown in TABLE I (below), are relevant to almost any electrode material application that uses commercial gas-shielded flux cored arc consumables.

TABLE I
Experimental Data
0.045-inch HES-FCA 316L PARAMETERS TABLE

| | | TRANS- | AMPER- | VOLT- | Travel | | | | RADIO- |
|---|---|---|---|---|---|---|---|---|---|
| | | FER | AGE | AGE | Speed | WFS | FLOW | VISUAL | GRAPHIC |
| TYPE | APPARATUS | MODE | (A) | (V) | (IPM) | (IPM) | (CFH) | TESTING | TESTING |
| DED | WITH | CV | 170 | 25 | 16 | 425 | 4 | PASS | PASS |
| WALL | | | | | | | | | |
| DED | WITHOUT | CV | 172 | 25 | 16 | 425 | 4 | FAIL | N/A |
| WALL | | | | | | | | | |

Single-pass per layer (wall) tests were used to compare conventional gas shielded flux cored arc (GS-FCA) DED to HES-FCA DED. In these experiments, constant voltage (CV) parameters were selected, and the conventional GS-FCAW DED utilized a ⅝ inch inside diameter nozzle with the contract tip recessed ⅛ (3-mm) at 4 CFH. The contact tip-to-work distance (CTWD) was ⅝-inch. When the HES apparatus/system was used, the resultant shielding cup-to-work distance (SCWD) was ½-inch. The HES-FCA DED parameters shown in TABLE I above were used with a 0.045-inch 316L stainless steel welding consumable to make a single pass per layer wall test. The wire feed speed was set to 425-ipm, and the travel speed was set to 16-ipm. The arc length was ⅛-inch at 25 volts. These parameters made a deposit that was approximately 0.080-inch thick. These deposits were approximately ½ inch (12.7-mm) wide. The shielding gas was set to 4 CFH, for comparison with a shielding gas flow that is feasible with the HES-FCA and also to demonstrate that a ⅝-inch diameter nozzle requires a higher flow rate to ensure a porosity free deposit. As previously mentioned, the recommended gas shielding flow rate for a ⅝-inch nozzle is typically 30-35 CFH. The conventional GS-FCA torch wall DED test produced surface breaking porosity at 4 CFH flow rate and was terminated after 6 beads. The conventional torch test produced unacceptable surface quality based on visual weld inspection requirements. The surface was uneven due to such deposits, which became worse with the second and third subsequent layers. The third layer was unacceptable/unfit for subsequent layering.

As previously discussed, a 30-50 CFH shielding gas “flow rate” is typical for commercial welding torches used in both automated DED and welding systems. Flow rate is dependent on and increases with gas cup (nozzle) and deposit pool size. The disclosed HES-FCA encapsulating arc torch apparatuses make high-quality deposits at as low as about 4 CFH flow rate with 316L stainless steel welding consumables. In addition to DED and wire arc additive manufacturing, the systems, methods, and devices disclosed herein also have utility in welding and joining applications.

The disclosed experimental data was generated using AWS E316LT0-3 on a DED wall application, but it is to be appreciated that variants of the disclosed methods are applicable to other steels, stainless steels, nickel alloys, etc. that are welded with other gas shielded flux cored arc consumables. It is also to be appreciated that the disclosed technology can work with other commercial gas shielded flux cored arc electrodes to use less shielding gas.

### Experiment 2

This experiment evaluated the effects of the disclosed high-efficiency shielded systems in a second electrode application involving a High-Efficiency Shielded (HES) gas metal arc (GMA) wall directed energy deposition (DED) process with ER70S-6 steel consumables. The results of this experiment are relevant to almost any electrode material application that uses commercial gas-shielded gas metal arc consumables. The ER70S-6 parameters and the results are shown in TABLE II, below.

TABLE II
Experimental Data
0.045-inch ER70S-6 PARAMETERS TABLE

| | | TRANS- | AMPER- | VOLT- | Travel | | | | RADIO- |
|---|---|---|---|---|---|---|---|---|---|
| | | FER | AGE | AGE | Speed | WFS | FLOW | VISUAL | GRAPHIC |
| TYPE | APPARATUS | MODE | (A) | (V) | (IPM) | (IPM) | (CFH) | TESTING | TESTING |
| DED | WITH | PULSE | 167 | 23.5 | 14 | 275 | 10 | PASS | PASS |
| WALL | | | | | | | | | |
| DED | WITHOUT | PULSE | 169 | 22.4 | 14 | 275 | 10 | FAIL | N/A |
| WALL | | | | | | | | | |

Single-pass per layer (wall) tests were used to compare conventional shielded gas metal arc welding DED to HES-GMA DED. As previously discussed, GMA and HES-GMA processes can utilize pulse waveforms and optimized parameters providing spatter-free metal transfer and high-quality deposits for DED. In this experimentation, optimized pulse parameters were selected to provide spatter-free metal transfer and pulse drop transfer for both conditions. Two DED wall tests were made with 100% CO₂ shielding gas to compare welds with and without the disclosed HES apparatus/system. The main difference between these tests was the setup conditions.

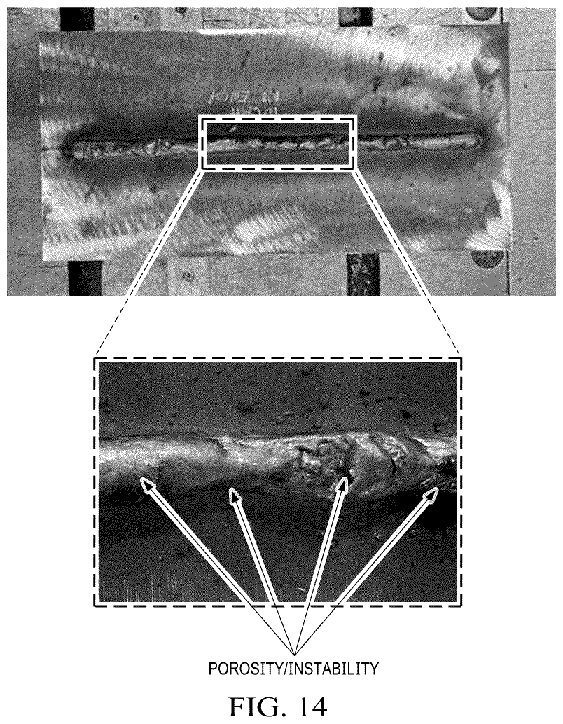

In these experiments, the conventional GMA DED utilized a ⅝-inch inside diameter nozzle with the contact tip recessed ⅛-inch (3-mm) at 10 CFH. The contact tip-to-work distance (CTWD) was ⅝-inch. When the HES apparatus/system was used, the resultant shielding cup-to-work distance (SCWD) was ½-inch. The GMA DED parameters shown in TABLE II above were used with a 0.045-inch ER70S-6 electrode to make a single pass per layer wall test. The wire feed speed was set to 275-ipm, and the travel speed was set to 14-ipm. The arc length was ⅛-inch at 22.4 volts. These parameters made a deposit that was approximately 0.080-inch thick. These deposits were approximately ½-inch (12.7-mm) wide. The shielding gas was set to 10 CFH, for comparison with a shielding gas flow that is feasible with the HES-GMA and also to demonstrate that a ⅝-inch diameter nozzle requires a higher flow rate to ensure a porosity free deposit. As previously mentioned, the recommended gas shielding flow rate for a ⅝-inch nozzle is typically 30-35 CFH. The conventional GMA torch wall DED test produced surface breaking porosity, as shown in FIG. 14, at 10 CFH flow rate and was terminated after 6 beads. The conventional torch test produced unacceptable surface quality based on visual weld inspection requirements. The surface was uneven due to such deposits, which became worse with the second and third subsequent layers. The third layer was unacceptable/unfit for subsequent layering.

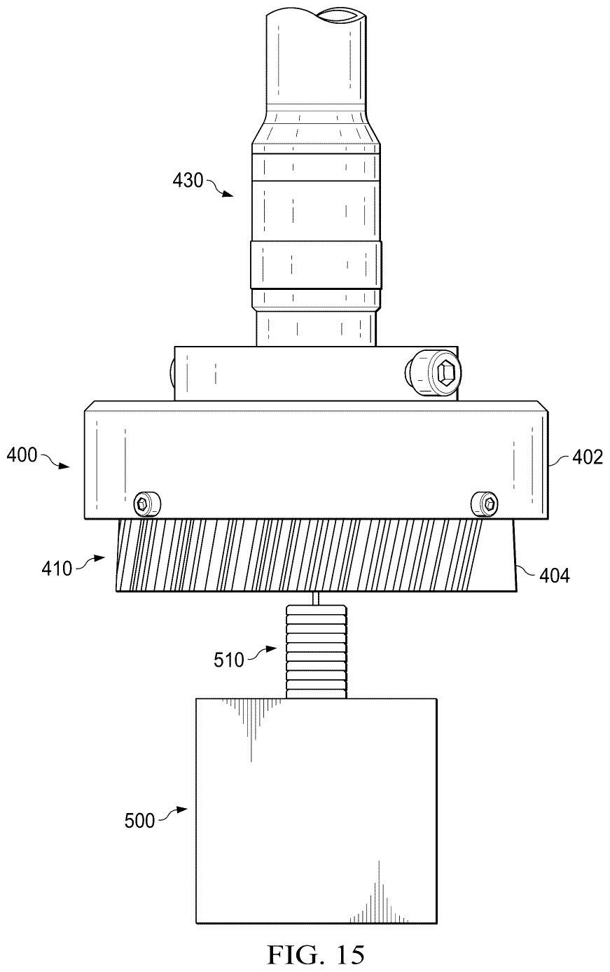

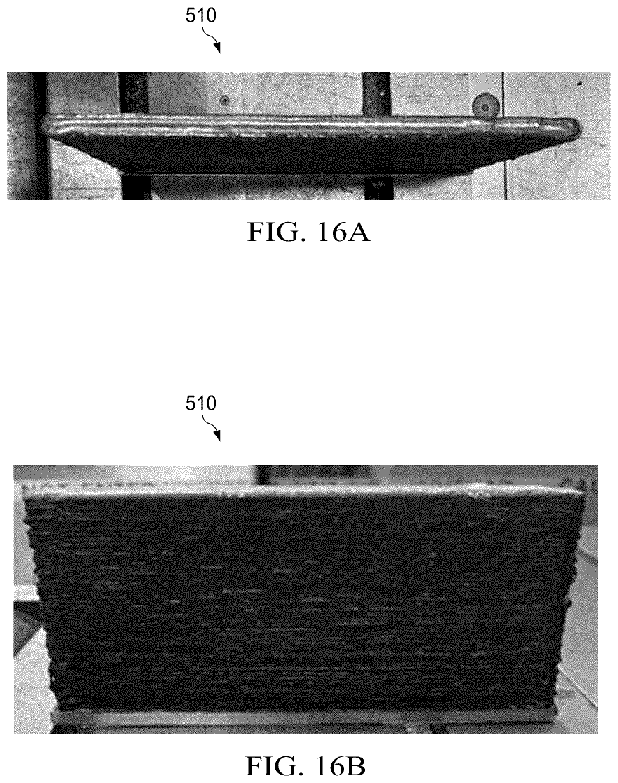

FIG. 15 depicts the HES encapsulating apparatus 400 used in the described experiment, which includes a 2.75-inch inside diameter cup with wire brush skirt 410. The CTWD was ⅝-inch, and the SCWD was about 0.080-inch where wire brush skirt 410 slid along the top of the deposit as it was formed on work surface 500. Wire brush skirt 410 did not require precise SCWD control because wire brush skirt 410 could flex to accommodate small changes in deposit height as the deposit was made. The GMA DED parameters shown in TABLE II above were used with a 0.045-inch ER70S-6 electrode to perform a single pass per layer wall test. The wire feed speed was set to 275-ipm and the travel speed was set to 14-ipm. The arc length was ⅛-inch at 23.5 volts. These parameters resulted in a deposit that was about 0.080-inch thick and such deposits were about ½-inch wide. The HES-GMAW torch test deposits were produced using the same shielding gas flow rate shielding condition of 10 CFH. The disclosed HES-GMA DED parameters of TABLE II were used to build wall 510 having 91 layers. Wall 510 was approximately 6-inches tall with no defects, as depicted in FIGS. 16A-16B. Wall 510 was radiographically inspected and found to be defect-free with no internal porosity.

As previously discussed, a 30-50 CFH shielding gas “flow rate” is typical for commercial welding torches used with automated DED systems. Flow rate is dependent on and increases with gas cup (nozzle) and deposit pool size. The disclosed HES-GMA encapsulating arc torch apparatuses make high-quality deposits at as low as about 10 CFH flow rate with standard ER70S-6 steel welding consumables. In addition to DED and wire arc additive manufacturing, the systems, methods, and devices disclosed herein also have utility in welding and joining applications.

The disclosed experimental data was generated using AWS ER70S-6 on a DED wall application, but it is to be appreciated that variants of the disclosed methods are applicable to other steels, stainless steels, nickel alloys, etc. that are welded with other gas-shielded GMA consumables. It is also to be appreciated that the disclosed technology can work with other commercial GMA electrodes to use less shielding gas.

### Experiment 3

This experiment evaluated the effects of the disclosed high-efficiency shielded systems in a third electrode application utilizing a High-Efficiency Shielded (HES) gas metal arc (GMA) V-groove directed energy deposition (DED) process with ER70S-6 steel consumables and 100% CO₂ shielding gas. The results of this experiment are relevant to almost any electrode material application that uses commercial gas-shielded gas metal arc consumables and recommended shielding gases. The ER70S-6 parameters and the results are shown in TABLE III, below.

TABLE III
Experimental Data
0.045-inch ER70S-6 PARAMETERS TABLE

| | | TRANS- | AMPER- | VOLT- | Travel | | | | RADIO- |
|---|---|---|---|---|---|---|---|---|---|
| | | FER | AGE | AGE | Speed | WFS | FLOW | VISUAL | GRAPHIC |
| TYPE | APPARATUS | MODE | (A) | (V) | (IPM) | (IPM) | (CFH) | TESTING | TESTING |
| 0.5-in V- | WITH | PULSE | 174 | 22.7 | 14 | 275 | 10 | PASS | PASS |
| GROOVE | | | | | | | | | |
| 0.5-in V- | WITHOUT | PULSE | 169 | 22.5 | 14 | 275 | 10 | FAIL | N/A |
| GROOVE | | | | | | | | | |

In this experiment, HES-GMAW and conventional GMAW processes were demonstrated for welding ½-inch thick V-groove butt joints on mild steel. Both butt joint tests were made with 100% CO₂ shielding gas to compare welds made with the disclosed HES apparatus for the HES-GMAW process and without the HES apparatus for the conventional GMAW process. The conventional GMAW butt joint was completed in 10 passes, whereas the HES-GMAW process was completed in 14 passes. The conventional GMAW butt joint required fewer passes because the deposits contained subsurface porosity that resulted in larger deposits. Each butt joint was visually examined for surface quality and radiographically inspected to evaluate soundness.

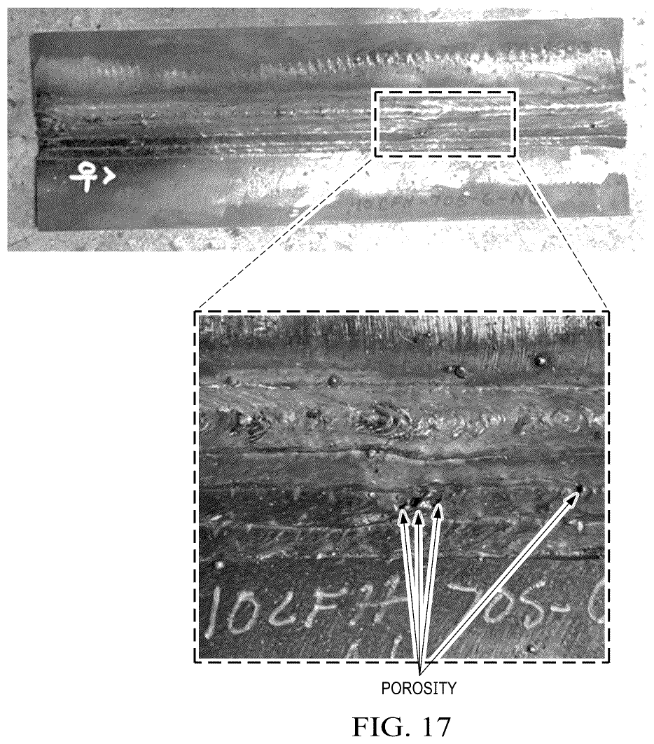

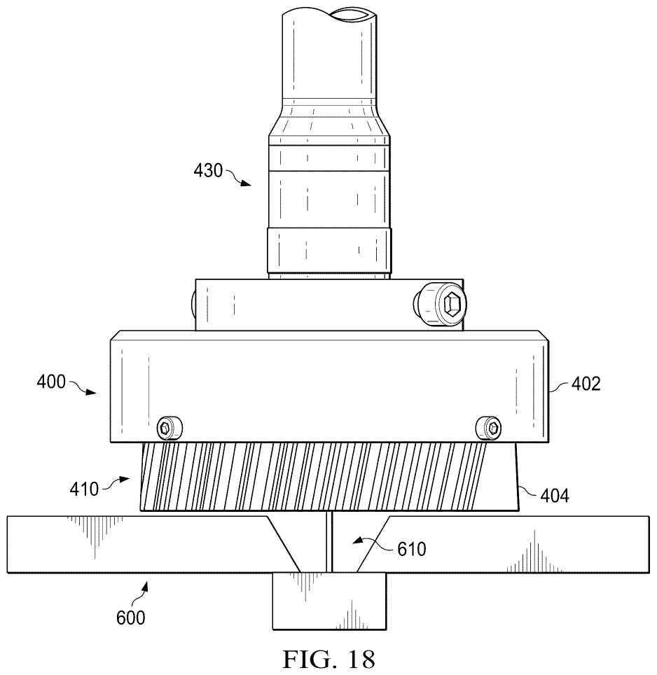

The conventional GMAW utilized a ⅝-inch inside diameter nozzle, with the contact tip recessed ⅛-inch (3-mm) at 10 CFH. For the root pass, the contact tip was set flush with the nozzles to provide a ⅛-inch clearance for traveling over the groove. For all passes, the contact tip-to-work distance (CTWD) was ⅝-inch. When the HES apparatus was used, the resultant shielding cup-to-work distance (SCWD) was ½-inch for all passes, except for the root pass where the SCWD was ⅝-inch. The GMAW parameters listed in Table III above were used with an 0.045-inch ER70S-6 electrode to fill the V-groove butt joint in 10 passes. The wire feed speed was set to 275-ipm, and the travel speed was set to 14-ipm. The arc length was ⅛-inch at 22.5 volts. These parameters made a deposit that was approximately 0.080-inch thick, and such deposits were approximately ½-inch (12.7-mm) wide. The shielding gas was set to 10 CFH for comparison with a shielding gas flow that is feasible with the HES-GMA and also to demonstrate that a ⅝-inch diameter nozzle requires a higher flow rate to ensure a porosity free deposit. As previously mentioned, the recommended gas shielding flow rate for a ⅝-inch nozzle welding is typically 30-35 CFH. In this experiment, the conventional GMAW welding test produced small surface breaking porosity, as shown in FIG. 17. The conventional torch test produced unacceptable surface quality based on visual weld inspection requirements that included surface breaking small pores and excess spatter. This conventional torch test was not radiographed since it failed visual testing.

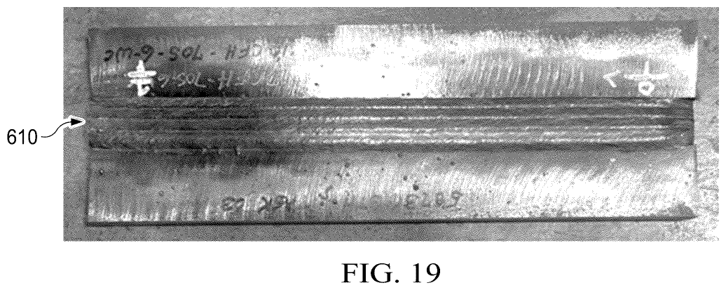

FIG. 18 depicts the disclosed HES encapsulating apparatus 400 used in this experimentation with a 2.75-inch inside diameter cup with wire brush skirt 410. The CTWD was ⅝-inch for each weld deposit, and the SCWD was adjusted for each deposit to slide along the top of V-groove work surface 600. Wire brush skirt 410 did not require precise SCWD control because wire brush skirt 410 could flex to accommodate small changes in CTWD as the deposit was made. The HES-GMAW welding parameters listed in TABLE III (above) were used with a 0.045-inch ER70S-6 electrode to make V-groove 610 in 14 passes. The wire feed speed was set to 275-ipm, and the travel speed was set to 14-ipm. The arc length was ⅛-inch at 22.7 volts. The disclosed parameters made welds that were approximately 0.080-inch thick and these deposits were approximately ½-inch wide. The HES-GMAW welds were produced using the same shielding gas flow rate shielding condition of 10 CFH. The HES-GMA DED parameters were used to complete V-groove 610 butt joint in 14 passes. All passes were visually acceptable and the resultant V-groove weld 610 contained no defects, as shown in FIG. 19. The HES-GMAW V-groove test was radiographically inspected and found to be defect free with no internal porosity.

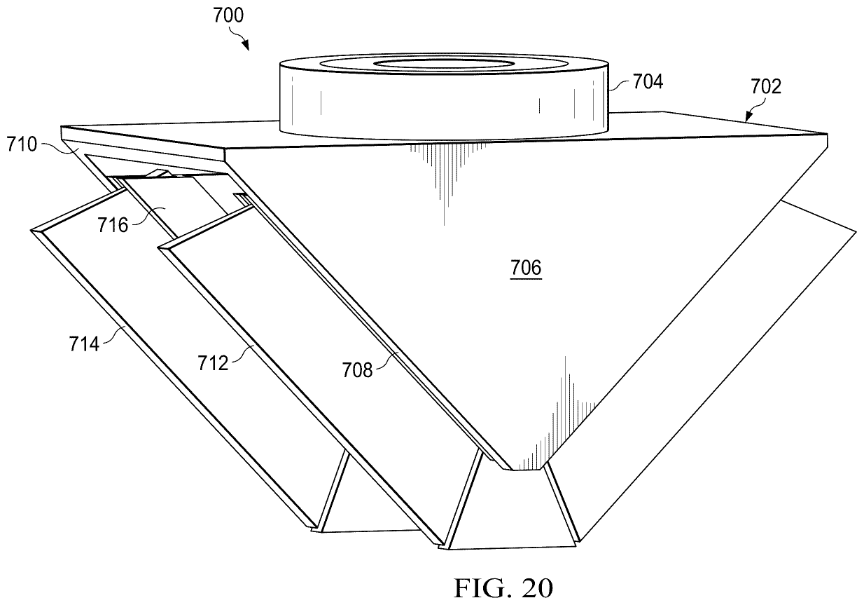

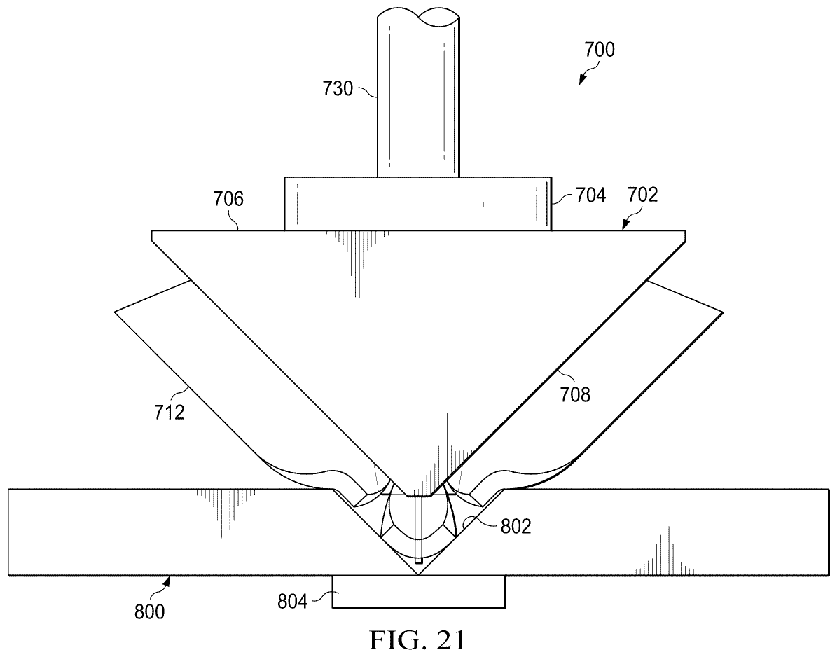

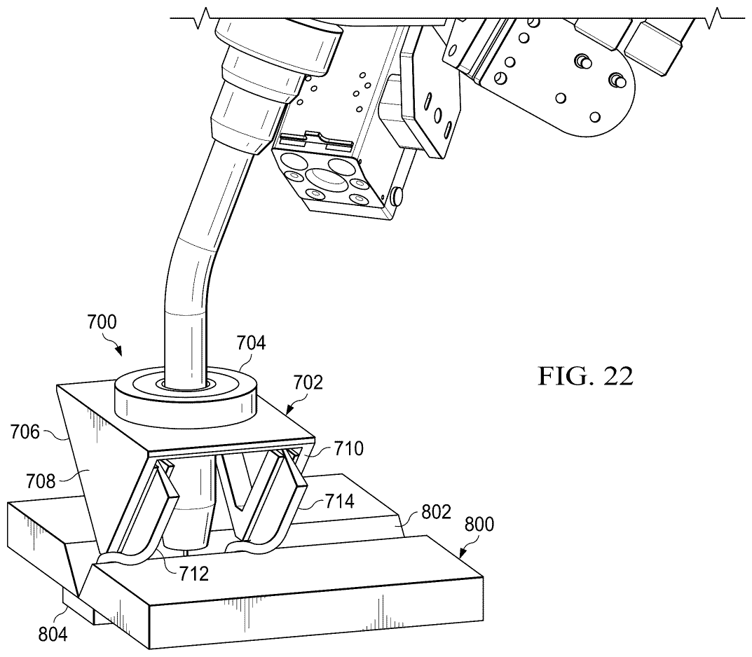

FIG. 20 provides a front, perspective view of a fifth example implementation of the disclosed encapsulating apparatus, wherein the encapsulating apparatus includes a frame having a predetermined geometry that corresponds to the geometry of a particular type of groove, and wherein the frame serves as a substrate to which front, rear, and side shields are attached for enclosing a welding torch within the apparatus; FIG. 21 depicts the encapsulating apparatus of FIG. 20 being used within an example (V-shaped) groove geometry, wherein the groove includes a backing bar and is beveled at a 45° angle; and FIG. 22 depicts the encapsulating apparatus of FIG. 20 attached to a welding torch and with the side shielding removed to illustrate the placement of the welding torch within the encapsulating apparatus and V-shaped groove. As shown in FIGS. 20-22, encapsulating apparatus 700 includes frame 702, having upper portion/collar 704 and lower portion 706, which includes front bracket 708 and rear bracket 710. Front shield 712 is mounted on front bracket 708 and rear shield 714 is mounted on rear bracket 710. Side shields 716 are mounted between front bracket 708 and rear bracket 710 for completely enclosing welding torch 730 within encapsulating apparatus 700. Side shields 716 may include brushes, tape, and/or thin metal sheets that permit encapsulating apparatus 700 to flexibly move over a workpiece uninhibited by a completely metal enclosure. Work surface 800 includes V-shaped groove 802 having a backing bar (804). This embodiment can be adapted to different groove geometries for various weld types (e.g., joint, fillet, lap, groove, etc.). Encapsulating apparatus 700 may be attached to welding torch 730 using one or more set screws or other mechanical attachments.

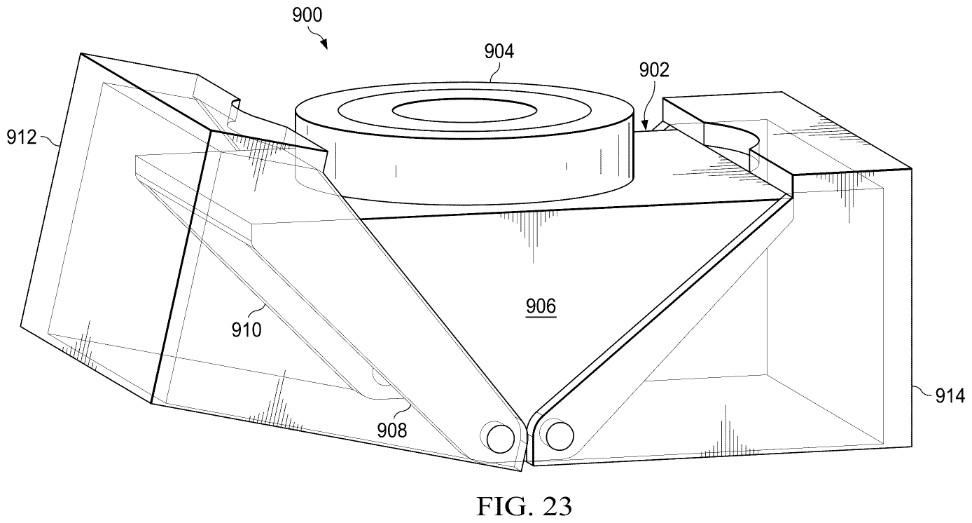

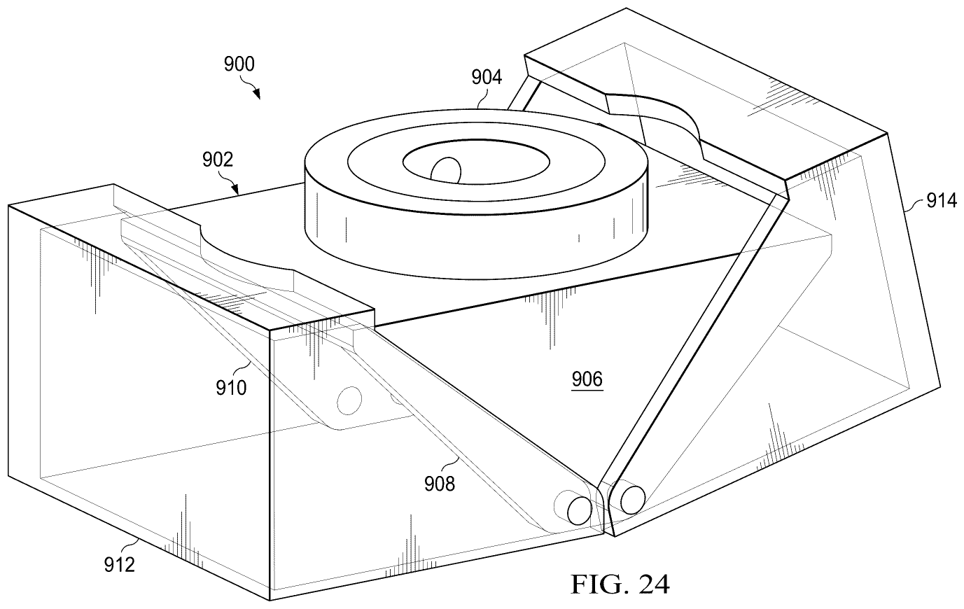

FIGS. 23-24 provide two front, perspective views of a sixth example implementation of the disclosed encapsulating apparatus, wherein the encapsulating apparatus includes a frame having a predetermined geometry that corresponds to the geometry of a particular type of groove, and wherein the frame serves as a substrate to which first and second pivoting side shields are attached for enclosing a welding torch within the apparatus. As shown in FIGS. 23-24, encapsulating apparatus 900 includes frame 902, having upper portion/collar 904 and lower portion 906, which includes front bracket 908 and rear bracket 910. First pivoting side shield 912 and second pivoting side shield 914 are attached to from 902 as shown. Pivoting side shields 912 and 914 are adjustable either manually, or through the use of motors when the apparatus is used in robotic or automatic applications, wherein adjustments to the height of the encapsulating apparatus relative to the groove and/or workpiece may be made in real time for both welding and DED procedures. The outer geometry of encapsulating apparatus 900 may be modified for use in a variety of welding and/or DED applications and the pivoting side shields can be repositioned or otherwise adjusted to accommodate grooves, fillets, or lap joints.

As previously discussed, 30-50 CFH shielding gas “flow rate” is typical for commercial welding torches depending on the cup size used with automated DED systems. Flow rate is dependent on and increases with gas cup (nozzle) and deposit pool size. The disclosed HES-GMA encapsulating arc torch apparatuses make high quality groove welds at as low as 10 CFH flow rate with standard ER70S-6 steel welding consumables. In addition to DED and wire arc additive manufacturing, the systems, methods, and devices disclosed herein also have applications in the welding and joining space.

Experimental data was generated using AWS ER70S-6 on a V-groove welding application, but it is to be appreciated that variants of the disclosed methods are applicable to other steels, stainless steels, nickel alloys, etc. that are welded with other gas-shielded GMA consumables and recommended shielding gases. It is also to be appreciated that the disclosed technology can work with other commercial GMA electrodes to use less shielding gas.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differ from or contradict this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about”, if or when used throughout this specification describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed technology. Various functions and elements described herein may be partitioned differently from those shown without departing from the scope of the disclosed technology. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the Figures, only for facilitating description of the disclosed technology and simplifying the description, rather than indicating or implying that the referred devices or elements must be in a particular orientation or constructed or operated in the particular orientation, and therefore they should not be construed as limiting the disclosed technology. The terms “connected”, “mounted”, “fixed”, etc. should be understood in a broad sense. For example, “connected” may be a fixed connection, a detachable connection, or an integral connection, a direct connection, or an indirect connection through an intermediate medium. For one of ordinary skill in the art, the specific meaning of the above terms in the disclosed technology may be understood according to specific circumstances.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

What is claimed:

1. A device for use with welding systems and processes, comprising;
(a) an encapsulating apparatus configured to encapsulate a welding torch nozzle at the tip thereof, wherein the encapsulating apparatus includes:
(i) an upper body portion which mounts on the welding torch nozzle; and
(ii) a lower body portion which extends beyond the tip of the welding torch nozzle toward a work surface; and
(b) wherein during a welding process, the encapsulating apparatus encapsulates a welding electrode passing through the tip of the welding torch nozzle, an arc generated by the welding torch, and a weld pool surface directly above the work surface during deposition of the weld pool, and
(c) wherein the encapsulating apparatus prevents atmospheric gases from entering the weld pool during the welding process using shielding gas flowing at a predetermined flow rate.

2. The device of claim 1, wherein the welding process is a high efficiency, gas shielded, gas metal, or flux cored arc welding-based process.

3. The device of claim 2, wherein the welding process is used for directed energy deposition additive manufacturing.

4. The device of claim 1, wherein the encapsulating apparatus is made from a high-conductivity material that prevents radiant heat from the welding process from causing changes in the geometry of the encapsulating apparatus.

5. The device of claim 4, wherein the high-conductivity material is copper, one or more copper alloys, or other alloy material.

6. The device of claim 1, wherein the upper body portion is cylindrical and includes an internal channel having a diameter slightly greater than an outer diameter of the welding torch.

7. The device of claim 1, wherein the lower body portion includes an outer diameter that is the same as the outer diameter of the upper body portion, and wherein the lower body portion includes an inner diameter that is the same as the inner diameter of the upper body portion.

8. The device of claim 1, wherein the lower body portion includes a single bead wall design having a tunnel feature that improves encapsulation for thin weld or deposit additive manufacturing features.

9. The device of claim 1, wherein the lower body portion is machined to match a welding groove profile on the work surface while providing clearance for the weld pool and a minimal gap to travel over the work surface without contact.

10. The device of claim 1, wherein the lower body portion includes a cutout region that improves encapsulation for bulk weld features.

11. The device of claim 1, wherein the lower body portion includes an omni-directional skirt feature that is configured to minimize gap or allow sliding contact over the work surface.

12. The device of claim 1, wherein the lower body portion includes a frame having a predetermined geometry that corresponds to the geometry of a particular type of groove, and wherein the frame serves as a substrate to which front, rear, and side shields are attached for enclosing a welding torch within the device.

13. The device of claim 1, wherein the lower body portion includes a frame having a predetermined geometry that corresponds to the geometry of a particular type of groove, and wherein the frame serves as a substrate to which first and second pivoting side shields are attached for enclosing a welding torch within the device.

14. The device of claim 1, wherein the encapsulating apparatus includes a mechanism for adjusting the position of the encapsulating apparatus on the welding torch nozzle in an upward or downward manner.

15. A device for use with welding systems and processes, comprising;
(a) an encapsulating apparatus configured to encapsulate a welding torch nozzle at the tip thereof, wherein the encapsulating apparatus includes:
(i) an upper body portion which mounts on the welding torch nozzle; and
(ii) a lower body portion which extends beyond the tip of the welding torch nozzle toward a work surface; and
(b) wherein during a welding process, the encapsulating apparatus encapsulates a welding electrode passing through the tip of the welding torch nozzle, an arc generated by the welding torch, and a weld pool surface directly above the work surface during deposition of the weld pool,
(c) wherein the encapsulating apparatus prevents atmospheric gases from entering the weld pool during the welding process, and
(d) wherein the welding process is a high efficiency, gas shielded, gas metal, or flux cored arc welding-based process used for directed energy deposition additive manufacturing.

16. The device of claim 15, wherein the encapsulating apparatus is made from a high-conductivity material that prevents radiant heat from the welding process from causing changes in the geometry of the encapsulating apparatus, and wherein the high-conductivity material includes copper or a material similar to copper.

17. The device of claim 15, wherein the lower body portion includes an outer diameter that is the same as the outer diameter of the upper body portion, and wherein the lower body portion includes an inner diameter that is the same as the inner diameter of the upper body portion.

18. The device of claim 15, wherein the lower body portion includes either a single bead wall design having a tunnel feature that improves encapsulation for thin weld features; a cutout region that improves encapsulation for bulk weld features; or an omni-directional skirt feature.

19. The device of claim 15, wherein the lower body portion includes a frame having a predetermined geometry that corresponds to the geometry of a particular type of groove, and wherein the frame serves as a substrate to which front, rear, and side shields are attached for enclosing a welding torch within the device, or to which first and second pivoting side shields are attached for enclosing a welding torch within the device.

20. The device of claim 15, wherein the encapsulating apparatus includes a mechanism for adjusting the position of the encapsulating apparatus on the welding torch nozzle in an upward or downward manner.

21. A device for use with welding systems and processes, comprising;
(a) an encapsulating apparatus configured to encapsulate a welding torch nozzle at the tip thereof, wherein the encapsulating apparatus includes:
(i) an upper body portion which mounts on the welding torch nozzle; and
(ii) a lower body portion which extends beyond the tip of the welding torch nozzle toward a work surface; and
(b) wherein during a welding process, the encapsulating apparatus encapsulates a welding electrode passing through the tip of the welding torch nozzle, an arc generated by the welding torch, and a weld pool surface directly above the work surface during deposition of the weld pool,
(c) wherein the encapsulating apparatus prevents atmospheric gases from entering the weld pool during the welding process,
(d) wherein the welding process is a high efficiency, gas shielded, gas metal, or flux cored arc welding-based process used for directed energy deposition additive manufacturing, and
(e) wherein the encapsulating apparatus is made from a high-conductivity material that prevents radiant heat from the welding process from causing changes in the geometry of the encapsulating apparatus.

22. The device of claim 21, wherein the lower body portion includes an outer diameter that is the same as the outer diameter of the upper body portion, and wherein the lower body portion includes an inner diameter that is the same as the inner diameter of the upper body portion.

23. The device of claim 22, wherein the lower body portion includes either a single bead wall design having a tunnel feature that improves encapsulation for thin weld features; a cutout region that improves encapsulation for bulk weld features; or an omni-directional skirt feature.

24. The device of claim 23, wherein the lower body portion includes a frame having a predetermined geometry that corresponds to the geometry of a particular type of groove, and wherein the frame serves as a substrate to which front, rear, and side shields are attached for enclosing a welding torch within the device, or to which first and second pivoting side shields are attached for enclosing a welding torch within the device.
